(19) United States
(12) Patent Application Publication
(10) Pub. No.: US 2022/0283090 A1
(43) Pub. Date: Sep. 8, 2022

(54) OPTICAL PHANTOM AND METHOD FOR CHARACTERIZING OPTICAL IMAGING SYSTEMS

(71) Applicant: Board of Trustees of the University of Illinois, Urbana, IL (US)

(72) Inventors: Mantas Zurauskas, Urbana, IL (US); Stephen A. Boppart, Champaign, IL (US)

(21) Appl. No.: 17/653,457

(22) Filed: Mar. 3, 2022

Related U.S. Application Data
(60) Provisional application No. 63/200,398, filed on Mar. 4, 2021.

(51) Int. Cl. G01N 21/64

(52) U.S. Cl. CPC G01N 21/6458; G01N 2201/127

(57) ABSTRACT

A calibration phantom, or related nanoparticle substrate, for multimodal optical system characterization includes a contrast layer and a localizing grid layer. The contrast layer may be a two-dimensional (2D) layer, a stack of 2D layers, a three-dimensional (3D) block, or combinations thereof. Nanoparticles are arranged on, embedded in, or coupled to the contrast layer(s). Nanoparticles provide sub-resolution point-sources that can provide optical contrast for multiple different imaging modalities. The localizing grid layer includes a grid, which may be etched in, or otherwise marked on, the localizing grid layer. By coupling the contrast layer to the localizing grid layer, the positions of the nanoparticles remain fixed relative to the localizing grid, which can be visualized by the imaging system. In this way, a reliable and repeatably imageable calibration phantom is provided.

### BACKGROUND

Multimodal optical microscopy systems, such as nonlinear fluorescence, harmonic generation, and/or other nonlinear processes-based imaging systems, require optical calibration phantoms that mimic signals generated by samples to provide stable reference images for system characterization and optimization during both development and deployment states. These multimodal imaging systems are often evaluated using fluorescent beads. Fluorescent beads are uniform in size and provide good sub-resolution point source for qualitative and quantitative system evaluation. Both excitation efficiency and optical performance of the systems can be assessed using this method. However, fluorescent beads bleach rapidly as they are being imaged and peak intensity drops during each subsequent image frame. As a result, longitudinal measurements of the same fluorescent beads are problematic. It is therefore difficult to compare the performance of multimodal imaging systems, whether between different systems or for the same system over time. A robust calibration phantom for multimodal imaging systems is desired.

### SUMMARY OF THE DISCLOSURE

The present disclosure addresses the aforementioned drawbacks by providing a calibration phantom that includes one or more contrast layers and a localizing grid layer. Each contrast layer is composed of an optically transparent material and has nanoparticles arranged on a surface of the layer. The localizing grid layer is composed of an optically transparent material and has a grid marked on a surface of the layer. The one or more contrast layers are coupled to the localizing grid layer such that a position of each nanoparticle is fixed relative to the grid marked on the localizing grid layer.

It is another aspect of the present disclosure to provide a calibration phantom that includes a contrast layer block and a localizing grid layer. The contrast layer block is composed of an optically transparent material and has nanoparticles embedded within the block. The localizing grid layer is composed of an optically transparent material and has a grid marked on a surface of the layer. The contrast layer block is coupled to the localizing grid layer such that a position of each nanoparticle is fixed relative to the grid marked on the localizing grid layer.

The foregoing and other aspects and advantages of the present disclosure will appear from the following description. In the description, reference is made to the accompanying drawings that form a part hereof, and in which there is shown by way of illustration a preferred embodiment. This embodiment does not necessarily represent the full scope of the invention, however, and reference is therefore made to the claims and herein for interpreting the scope of the invention.

### BRIEF DESCRIPTION OF THE DRAWINGS

FIG. 1 illustrates an example nanoparticle-based calibration phantom in accordance with some embodiments described in the present disclosure.

FIG. 2 illustrates an example localizing grid layer that can form a part of a nanoparticle-based calibration phantom.

FIG. 3 illustrates an alternative configuration of a nanoparticle-based calibration phantom, in which the calibration phantom includes multiple contrast layers.

FIG. 4 illustrates an alternative configuration of a nanoparticle-based calibration phantom, in which the calibration phantom includes a tissue-simulating layer coupled to a contrast layer.

FIG. 5 illustrates an alternative configuration of a nanoparticle-based calibration phantom, in which the calibration phantom includes a three-dimensional contrast layer block within which nanoparticles are embedded.

FIG. 6 is a widefield transmission image of an example localizing grid layer constructed by laser etching a grid pattern into a glass substrate.

FIG. 7 is a series of example images obtained from a calibration phantom constructed according to some embodiments described in the present disclosure.

FIG. 8 is another series of example images obtained from a calibration phantom constructed according to some embodiments described in the present disclosure

FIG. 9 illustrates a method for computing an approximate optical transfer function using a calibration phantom constructed according to some embodiments described in the present disclosure.

FIG. 10 illustrates an example nanoparticle-based calibration phantom in accordance with some embodiments described in the present disclosure, in which an electromagnetic coil is provided for modulating the optical properties of the nanoparticles within the calibration phantom.

FIG. 11A illustrates an example nanoparticle substrate assembly in accordance with some embodiments described in the present disclosure.

FIG. 11B illustrates an alternative configuration of a nanoparticle substrate assembly, in which the nanoparticle substrate assembly includes multiple contrast layers.

FIG. 11C illustrates an alternative configuration of a nanoparticle substrate assembly, in which the nanoparticle substrate includes a three-dimensional contrast layer block within which nanoparticles are embedded.

FIG. 12 illustrates an example nanoparticle substrate assembly in accordance with some embodiments described in the present disclosure, in which an electromagnetic coil is provided for modulating the optical properties and/or state(s) of the nanoparticles within the nanoparticle substrate assembly.

FIG. 13 is a block diagram of an example computing device that can be used to control the operation of an electromagnetic coil to generate and modulate a magnetic field.

### DETAILED DESCRIPTION

Described here is a calibration phantom for multimodal optical system characterization, and methods for its use. Related nanoparticle substrates are also described. The calibration phantoms and related nanoparticle substrates described in the present disclosure make use of nanocrystals, other crystalline nanomaterials, or other nanoparticle substrates that have vacancy centers, also referred to as color centers, or other defects as a contrast agent. For instance, materials such as nanodiamonds or silicon carbide (“SiC”) can be used as a contrast agent. The nanocrystals may have a single-crystalline arrangement or a poly-crystalline arrangement. Nanocrystals such as nanodiamonds or SiC provide sub-resolution point-sources that can provide optical contrast for multiple different imaging modalities. Advantageously, nanodiamonds and other nanocrystals are shelf-stable and not prone to bleaching. Using the calibration phantoms described in the present disclosure, the performance of a multimodal optical imaging system can be characterized, quantitatively measured, or otherwise assessed. Additionally or alternatively, the calibration phantoms can be used to characterize optical aberrations in the multimodal optical imaging system.

In general, the nanocrystals can have fluorescent color centers, and may also emit more than just fluorescence, including electromagnetic radiation resulting from scattering, harmonic generation, and/or other nonlinear interactions. Advantageously, by using nanocrystals with different shapes and/or responses, the calibration phantom or related nanoparticle substrate(s) can provide unique multimodal signatures. In this way, the calibration phantom or related nanoparticle substrate(s) can be designed for use with different linear and nonlinear optical interactions. As non-limiting examples, nanocrystals (e.g., nanodiamond or the like) can be used for single and multiphoton fluorescence imaging, transmission imaging, second harmonic generation, third harmonic generation, and so on. For instance, each nanocrystal (e.g., nanodiamond) can have a unique fingerprint of signals in various different imaging channels, such as 1-photon fluorescence (“1PF”), 2-photon fluorescence (“2PF”), 3-photon fluorescence (“3PF”), second harmonic generation (“SHG”), and third harmonic generation (“THG”) based imaging channels, as well as in other imaging channels based on coherent anti-Stokes Raman scattering (“CARS”), stimulated Raman scattering (“SRS”), fluorescence lifetime imaging (“FLIM”), bright-field microscopy, and so on.

Fluorescence signal is generated by nitrogen-vacancy (“NV”) and nitrogen-vacancy-nitrogen (“NVN”) centers induced in the nanodiamonds. As one example, NV centers can produce red fluorescence and NVN centers can produce green fluorescence. The nanodiamonds can thus be selected to have specific color centers depending on the imaging systems with which the calibration phantom will be used. As described above, the nanodiamonds can also provide SHG and THG signal generation, irrespective of doping. The nanodiamonds can also generate contrast for non-linear spectroscopic imaging such as CARS and SRS, among others.

Additionally or alternatively, nanoparticle substrates such as those described in the present disclosure can be manufactured, created, or otherwise configured to include two or more different vacancy centers or defects that can produce different optical signatures or states. For example, a nanocrystal such as a nanodiamond or silicon carbide can be configured to include different types of vacancy centers, such as NV centers, NVN centers, silicon-vacancy (“SiV”) centers, germanium-vacancy (“GeV”) centers, tin-vacancy (“SnV”) centers, lead-vacancy (“PbV”) centers, hydrogen-vacancy (“HV”) centers, hydrogen-nitrogen-vacancy (“HNV”) centers, nickel-vacancy (“NiV”) centers, and other suitable vacancy centers. The nanocrystals can include two or more different types of vacancy centers, such that different optical signatures or states can be produced by the nanocrystals. Advantageously, this configurability of the nanoparticle substrate can enable to nanoparticle substrate to have controllable quantum states not only for imaging, but also other applications such as quantum computing and quantum mechanical studies.

In some embodiments, the calibration phantom includes a multilayered construction, which may include two or more thin layers, or one or more thick layers in addition to one or more thin layers. In general, the calibration phantom includes at least one contrast layer and one localization grid layer. The nanodiamonds, other nanocrystals, or other nanoparticles are arranged on, embedded within, or otherwise coupled to the contrast layer, and the localization grid layer has marked thereon a grid that can be visualized using the multimodal imaging system. The contrast layer(s) and localization grid layer are held in a fixed relationship relative to each other, such that the grid provides reliable localization of the nanodiamonds, other nanocrystals, or other nanoparticles for repeatable imaging of the calibration phantom. As such, the calibration phantom provides a photostable calibration target that can be used for extended periods of time for system characterization, optimization, and quality control.

The contrast layer(s) can include a sparse two-dimensional (“2D”) or three-dimensional (“3D”) distribution of nanodiamonds, other nanocrystals, or other nanoparticles. In some configurations, the localizing grid layer can be doped or otherwise augmented with contrast media (e.g., a fluorescent dye or media) to facilitate visualization of the grid when imaged via one or more different imaging modalities.

Although nanodiamonds have been used for imaging purposes, they have not been adopted for use in calibrating instruments because each particle has a unique optical fingerprint. By combining the contrast layer(s) with a localizing grid layer, which is detectable in one or more imaging channels, the same nanodiamond particle or other nanoparticle can be located during multiple imaging sessions.

The nanoparticle substrate-based calibration phantoms described in the present disclosure can find use in a number of different applications. As one example, the calibration phantoms can be used for instrumentation development purposes by providing a photostable target during system optimization. As another example, the calibration phantoms can be used as a standard sample to provide a reference for normalizing image datasets during longitudinal studies, where other samples are imaged with multimodal optical systems. In still another example, the calibration phantoms can be integrated in commercial multimodal optical systems to provide a reference for instrument self-calibration.

As still another example, the phantoms described in the present disclosure can be used in other applications, such as measuring environmental temperature and/or measuring treatment-induced temperature changes in tissue phantoms that include the nanoparticle substrates described in the present disclosure. For instance, the nanoparticle substrate can be constructed to include nanodiamonds or other nanocrystals that are operable as quantum nanothermometers based on optically accessible electron spins in the nanocrystals. As a non-limiting example, laser light impinging upon a nanodiamond having a defect, such as an NV or other vacancy center, will be modulated based on the temperature of the vacancy center's electron spin. In this way, the light returned from the nanodiamond will depend on the temperature and, therefore, can be used to obtain ultrasensitive temperature measurements.

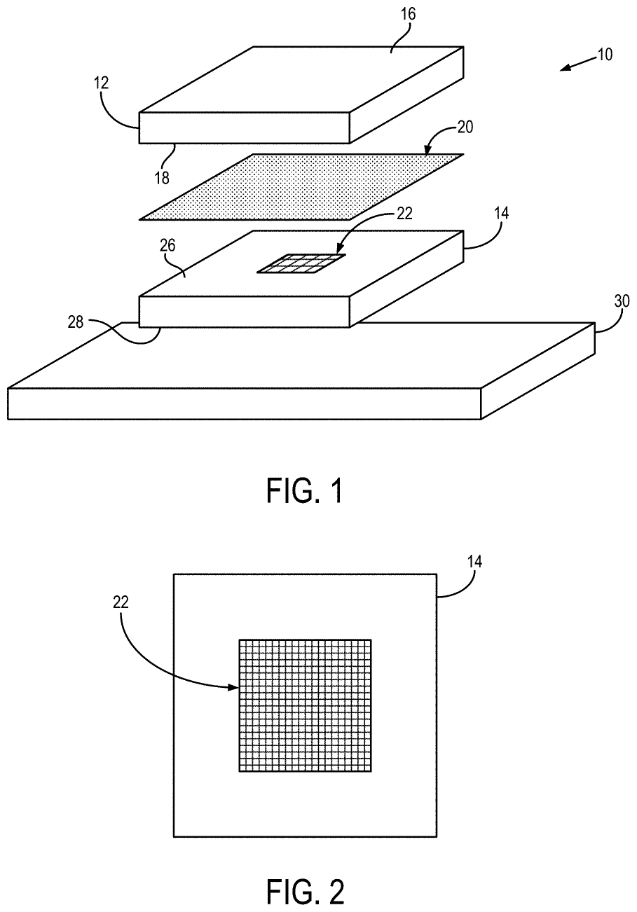

Referring now to FIG. 1, an example calibration phantom 10 according to some embodiments described in the present disclosure is shown. The calibration phantom 10 generally includes a contrast layer 12 and a localizing grid layer 14. The contrast layer 12 has an upper surface 16 and a lower surface 18. Nanoparticles 20 are arranged on, embedded within, or otherwise coupled to the contrast layer 12. The nanoparticles 20 can be coupled to the lower surface 18 of the contrast layer 12. Additionally or alternatively, the nanoparticles 20 can be coupled to the upper surface 16 of the contrast layer 12 and/or embedded within the contrast layer 12.

As described above, the nanoparticles include nanoparticles having defects (e.g., point defects or the like) that can be utilized to produce unique optical signatures or states. The nanoparticles may include nanocrystals, such as nanodiamonds or silicon carbide. The defects in the nanocrystals may include vacancy centers. In some embodiments, the nanocrystals can include two or more different types of vacancy centers or other defects. For instance, the nanocrystals may include two or more different types of vacancy centers (e.g., NV centers, NVN centers, SiV centers, GeV centers, SnV centers, PbV centers, and the like), such that the nanocrystals can provide different optical signatures or states based on the different types of vacancy centers included in the nanocrystals.

As a non-limiting example, the contrast layer 12 can be composed of a thin layer of an optically transparent material, such as glass, quartz, or an optically transparent polymer. In some configurations, the contrast layer 12 can include a coverslip. In these instances, the nanoparticles 20 can be arranged on, or otherwise coupled to, the upper surface 16 of the contrast layer 12, the lower surface 18 of the contrast layer 12, or both.

Like the contrast layer 12, the localizing grid layer 14 can be composed of a thin layer of an optically transparent material, such as glass, quartz, or an optically transparent polymer. The grid 22 can include regularly spaced regions or grid lines. Alternatively, the grid 22 can include one or more regions defined by irregularly spaced grid lines, irregularly sized regions, or both. The grid 22 can be a square grid, a rectangular grid, a triangular grid, or other suitably shaped grid. Further, the grid 22 can be composed of square regions, rectangular regions, triangular regions, hexagonal regions, or other suitably shaped regions arranged in a grid array.

As shown in FIG. 2, a grid 22 is marked on, or otherwise coupled to, the localizing grid layer 14. In a non-limiting example, the grid 22 can be etched (e.g., laser etched) onto the upper surface 26 of the localizing grid layer 14, the lower surface 28 of the localizing grid layer 14, or both. For instance, the grid 22 can be a 1 mm-by-1 mm laser-etched grid that is subdivided into 100 μm² regions. In these examples, laser machining ablates the glass, or other optically transparent material, along the grid lines leaving permanent grooves on upper surface 26, lower surface 28, or both, of the localizing grid layer 14 along the grid lines. The resulting grid 22 is visible in widefield transmission and SHG channels. The grooves of the grid 22 can be filled with fluorescent dyes or other materials that provide an optical contrast to further promote their visibility. Additionally or alternatively, the grid 22 can be composed at least partially from an optically opaque or semi-transparent material. For instance, the grid 22 may include an optically transparent base with an optically opaque or semi-transparent grid lines marked thereon.

In some embodiments, the calibration phantom 10 can further include a base layer 30. The contrast layer 12 and localizing grid layer 14 can be coupled to the base layer 30 to facilitate moving the calibration phantom 10 into and out of the imaging field-of-view of one or more imaging systems that are to be calibrated. The base layer 30 can be composed of a suitable material for supporting the contrast layer(s) 12 and/or localizing grid layer 14. In some instances, the base layer 30 may be composed of an optically transparent material. For example, the base layer 30 may be composed of glass, a polymer, or the like.

As a non-limiting example, the calibration phantom 10 can be constructed using a standard microscope slide as the base layer 30, a first coverslip for the contrast layer 12, and a second coverslip for the localizing grid layer 14. For instance, the contrast layer 12 may include a #1 coverslip with a sparse layer of nanoparticles 20 arranged on or otherwise coupled to the lower surface 18 of the contrast layer 12 coverslip. Additionally, the localizing grid layer 14 may include a coverslip with a laser-defined grid 22. For example, the laser-defined grid may be a 1 mm-by-1 mm grid subdivided into 100 μm² regions.

The calibration phantom 10 can be constructed by arranging nanoparticles 20 on the lower surface 18 of the contrast layer and then coupling the lower surface 18 of the contrast layer 12 to the upper surface 26 of the localizing grid layer 14. The lower surface 28 of the localizing grid layer 14 can then be coupled to a surface of the base layer 30. The edge around the contrast layer 12 and localizing grid layer 14 coverslips can be sealed with a sealant to prevent relative motion between the two layers, thereby establishing a consistent frame of reference for the nanoparticles 20 relative to the grid 22. As one non-limiting example, the sealant can be an epoxy, such as a UV-curable epoxy. Using UV curing provides several advantages, including hardening the epoxy and bleaching out autofluorescent impurities.

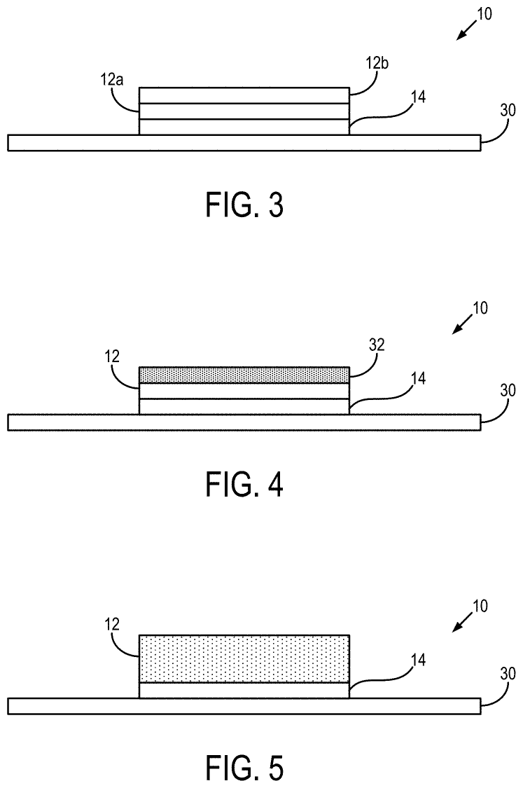

As shown in FIG. 3, in some examples, the calibration phantom 10 can include multiple contrast layers 12 arranged in a stack, arrayed, or otherwise arranged relative to each other. In these configurations, nanoparticles 20 can be arranged on, embedded within, or otherwise coupled to one or more of the contrast layers 12. In some configurations, different contrast layers 12 can be constructed to have different densities of nanoparticles 20. For example, the stack of contrast layers 12 may include a first contrast layer 12a having nanoparticle 20 arranged on a surface thereof at a first density, and a second contrast layer 12b having nanoparticles 20 arranged on a surface thereof at a second density that is different than the first density.

Additionally or alternatively, different contrast layers 12 can be constructed using different types of nanoparticles, or using nanoparticles with different types of vacancy centers or defects. For instance, the stack of contrast layers 12 may include a first contrast layer 12a having a first type of nanoparticle (e.g., nanodiamonds) arranged on a surface thereof, and a second contrast layer 12b having a second type of nanoparticles (e.g., silicon carbide) arranged on a surface thereof. As another example, the stack of contrast layers 12 may include a first contrast layer 12 a having nanoparticles 20 that include a first type of vacancy center (or first set of different vacancy center types) arranged on a surface thereof, and a second contrast layer 12b having nanoparticles 20 that include a second type of vacancy center (or second set of different vacancy center types) arranged on a surface thereof. In general, different contrast layers 12 can be configured to have different optical properties or characteristics by varying the types of nanoparticles, the types of defects (e.g., vacancy centers) included in the nanoparticles, varying the density of nanoparticles, varying other properties of the nanoparticles, and combinations thereof.

Additionally or alternatively, one or more tissue-simulating layers 32 can also be arranged in the stack, as shown in FIG. 4. For example, a tissue-simulating layer 32 can be a scattering layer composed of an optically transparent material, such as a polymer, that contains a scattering agent. As one non-limiting example, the scattering agent can be titanium dioxide to simulate tissue scattering properties. Additionally or alternatively, the tissue-simulating layer 32 can contain an absorbing agent. The one or more tissue-simulating layers 32 can also simulate other tissue properties, such as refractive index.

In some configurations, the tissue-simulating layer 32 can be constructed as physically separate from the contrast layer 12. Additionally or alternatively, the contrast layer 12 can be constructed to also contain one or more scattering agents and/or absorbing agents. For instance, the contrast layer 12 can be constructed to include both nanodiamonds and one or more scattering agents, such that the contrast layer 12 also functions as a tissue-stimulating layer to scatter electromagnetic radiation emitted by, or otherwise originating from, the nanodiamonds in the contrast layer 12.

In the examples described above, the contrast layer 12 is constructed as a thin layer of material and the nanoparticles 20 are arranged on or otherwise coupled to a surface of the contrast layer 12. In other examples, the nanoparticles 20 can be embedded within the contrast layer 12. The contrast layer 12 can in some instances be constructed as a thicker block of material, and the nanoparticles 20 can be arranged or otherwise distributed within the contrast layer 12 block. For example, the contrast layer 12 can be constructed as a 3D block in which nanoparticles 20 are embedded, as shown in FIG. 5. Additionally or alternatively, nanoparticles 20 can be arranged on or otherwise coupled to a surface of the contrast layer 12 block. As one non-limiting example, the contrast layer 12 block can be constructed as a single 3D block of polymer with nanoparticles 20 embedded therein. Similarly, in some embodiments the calibration phantom 10 can be constructed as a single, 3D block contrast layer 12 without a separate localizing grid layer 14. In these embodiments, the grid 22 can be a 3D grid that is embedded or otherwise constructed within the contrast layer 12 block. As one non-limiting example, the grid 22 can be defined in 3D using laser machining within the resin or other material used to construct the contrast layer 12 block.

It will be appreciated that the calibration phantom 10 can be constructed using any number of contrast layers 12 and/or tissue-simulating layers 32. For example, the calibration phantom 10 can be constructed with a single contrast layer 12 and a single tissue-simulating layer 32, a single contrast layer 12 and multiple different tissue-simulating layers 32, multiple contrast layers 12 and a single tissue-simulating layer 32, or multiple contrast layers 12 and multiple different tissue-simulating layers 32.

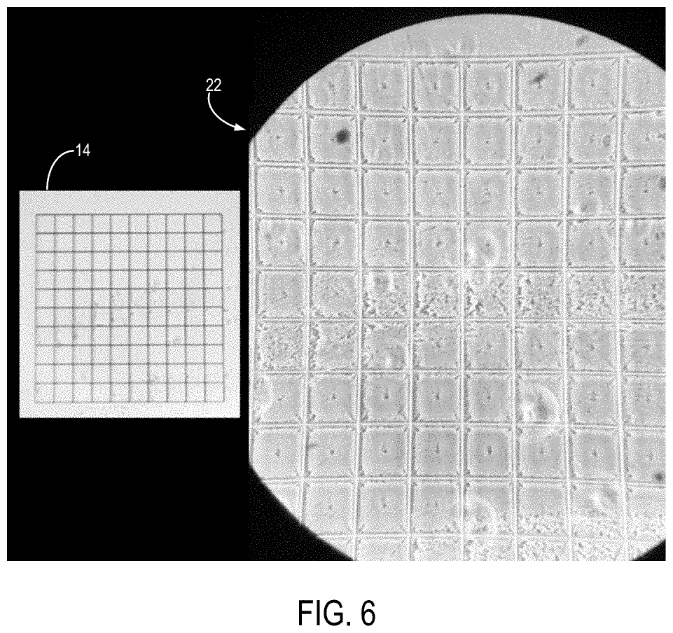

Referring now to FIG. 6, an example localizing grid layer is shown. In this example, the grid is marked on the localizing grid layer by laser etching the grid into the glass substrate of which the localizing grid layer is composed.

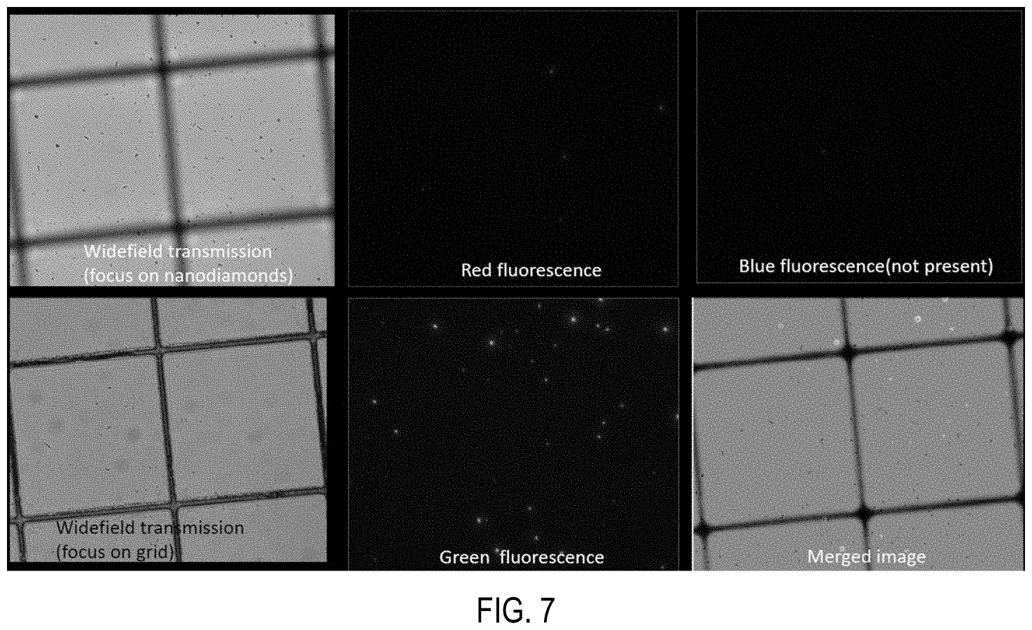

FIG. 7 shows a series of example images of a portion of a calibration phantom. The images include a widefield transmission images focused on the nanodiamonds, a widefield transmission image focused on the localizing grid, a red channel fluorescence image, a green channel fluorescence image, a blue channel fluorescence image, and a combined widefield transmission and fluorescence image. The combined image is generated by combining the widefield transmission image that is focused on the localizing grid with the red, green, and blue fluorescence channel images. The resulting combined image can be used for reliable and repeatable calibration of the imaging system since the location of the nanoparticles (e.g., nanodiamonds or other nanocrystals) remains fixed relative to the localization grid, which is visible in the combined image.

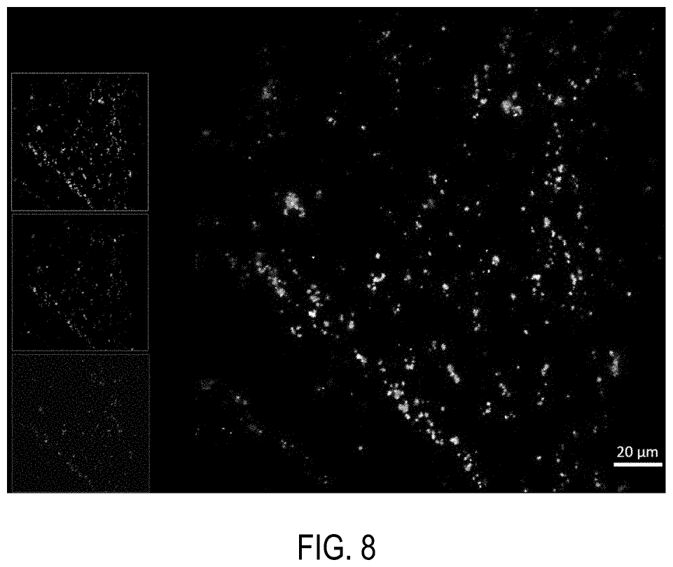

FIG. 8 shows an example composite 780 nm 20 mw image, generated by combining a 2PF channel image over 405-600 nm showing NVN vacancies, an SHG channel over 370-405 nm showing surface of nanodiamond crystals, and a CARS channel image over 633-657 nm showing NV vacancies.

An example method for depositing, arranging, or otherwise coupled nanoparticles 20 to the contrast layer 12 is now described. In this example, a solution of nanodiamonds is prepared by adding nanodiamonds to de-ionized water. As a non-limiting example, the nanodiamonds can include 700 nm nanodiamonds with red and green color centers. Different nanodiamonds can be used in other instances, depending on the desired imaging systems to be evaluated with the calibration phantom. It is an advantage of the calibration phantom described in the present disclosure that by using nanodiamonds with different shapes and/or responses, the calibration phantom provides unique multimodal signatures, which can be spatially localized across multiple imaging sessions by way of the localizing grid. The solution is then sonicated in an ultrasonic bath for one hour to disperse the nanodiamonds and break the aggregated particles. The desired concentration of nanodiamonds can be achieved by testing the initial solution and diluting it with de-ionized water as necessary.

To achieve a sparse 2D layer of nanodiamonds, a small amount of the prepared solution can be applied on the contrast layer (e.g., a glass coverslip) and the water is dried out. After drying, the nanodiamond particles remain dispersed across the surface of the contrast layer (e.g., coverslip) and tend to stick to the surface of the contrast layer. If necessary, to achieve better binding, additional binding-promoting agents, such as poly-1-lysine, poly(vinyl alcohol), or others, can be added to the nanodiamond solution before it is applied to the surface of the contrast layer.

The calibration phantoms described in the present disclosure can be used to measure a number of different quantitative measurements, which can be achieved using the sub-resolution nanodiamond emitters of the calibration phantoms. As one example, 3D point spread function (“PSF”) measurements can be made for quality assessment and deconvolution. System aberrations can then be retrieved from the measured 3D PSF, and the optical transfer function (“OTF”) of the imaging system can also be calculated using the 3D PSF.

As another example, excitation efficiency and excitation power measurements can be made. Together, these measurements provide a proxy measurement for pulse dispersion. A dense lawn of nanodiamonds provide sufficient information to capture excitation efficiency across the field-of-view for computational correction. The grid on the localizing grid layer can also serve as calibration for XY field-of-view size (scale bar).

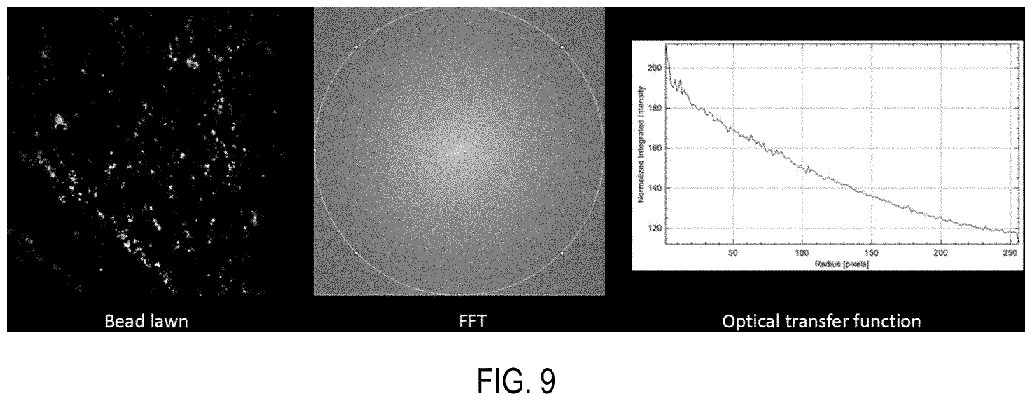

For example, as shown in FIG. 9, a dense lawn of nanodiamonds can be imaged, from which a 3D PSF of the imaging system can be estimated. By computing the Fourier transform (e.g., the fast Fourier transform (“FFT”)) of the 3D PSF, an estimation of the OTF can be measured, as shown.

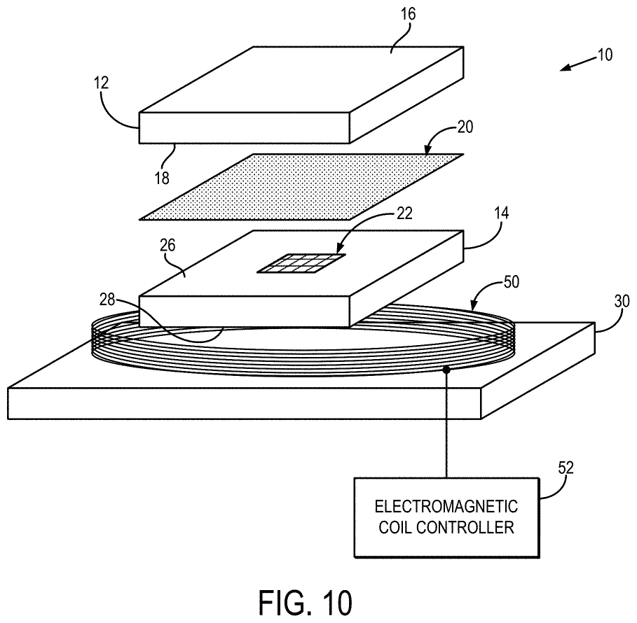

Referring now to FIG. 10, in some configurations the calibration phantom 10 can include an electromagnetic coil 50 that is operable to generate a magnetic field that can be controllably adjusted in order to modulate the fluorescence or other optical emission of the nanoparticles 20 in the contrast layer 12 or multiple different contrast layers 12. By modulating the magnetic field generated by the electromagnetic coil 50, the fluorescence and/or other optical properties of the nanoparticles 20 in the contrast layer 12 (or in different contrast layers 12) can be changed. This controllable change in the optical properties of the nanoparticles 20 advantageously allows for the nanoparticle signals to be unambiguously separated from any other sources of optical signals, such as those that may be generated by glass, resins, or other support materials used in the construction of the calibration phantom 10.

Additionally or alternatively, in embodiments where the nanoparticles 20 include two or more different types of defects (e.g., two or more different types of vacancy centers), the magnetic field can be used to change, modulate, or otherwise control the fluorescence, optical signature, optical state, and/or other optical properties of the nanoparticles 20. For example, changing the magnetic field can modulate the optical signature(s) produced by the nanoparticles 20 based on the different types of vacancy centers or other defects in the nanoparticles. Additionally or alternatively, in embodiments where the contrast layer 12 includes two or more contrast layers 12 (e.g., contrast layers 12a, 12b) the magnetic field can be used to change, modulate, or otherwise control the fluorescence, optical signature, optical state, and/or other optical properties of the nanoparticles 20 in the different contrast layers 12. For example, changing the magnetic field can modulate the optical signature(s) produced by the nanoparticles 20 in the different contrast layers 12 based on the different properties of characteristics (e.g., density, nanoparticle type, vacancy center type, sets of vacancy center types) of the nanoparticles 20 in the different contrast layers 12.

The electromagnetic coil 50 can be coupled to the base layer 30 of the calibration phantom 10. For instance, the electromagnetic coil 50 can be arranged on a surface of the base layer 30, or may be embedded in the base layer 30. Alternatively, the electromagnetic coil 50 can be coupled to other layers of the calibration phantom 10, including the contrast layer and/or the localizing grid layer 14. In still other configurations, the electromagnetic coil 50 can be physically separate from the calibration phantom 10, such as by being arranged so as to circumscribe all or part of the calibration phantom.

The electromagnetic coil 50 is controlled by an electromagnetic controller 52. The electromagnetic controller 52 can include electronic components for generating and controlling the magnetic field generated by the electromagnetic coil 50. In some embodiments, the electromagnetic coil controller 52 can include a computing device that can execute at least a portion of the control of the electromagnetic coil 50. The computing device can be any suitable computing device or combination of devices, such as a desktop computer, a laptop computer, a smartphone, a tablet computer, a wearable computer, a server computer, a virtual machine being executed by a physical computing device, and so on.

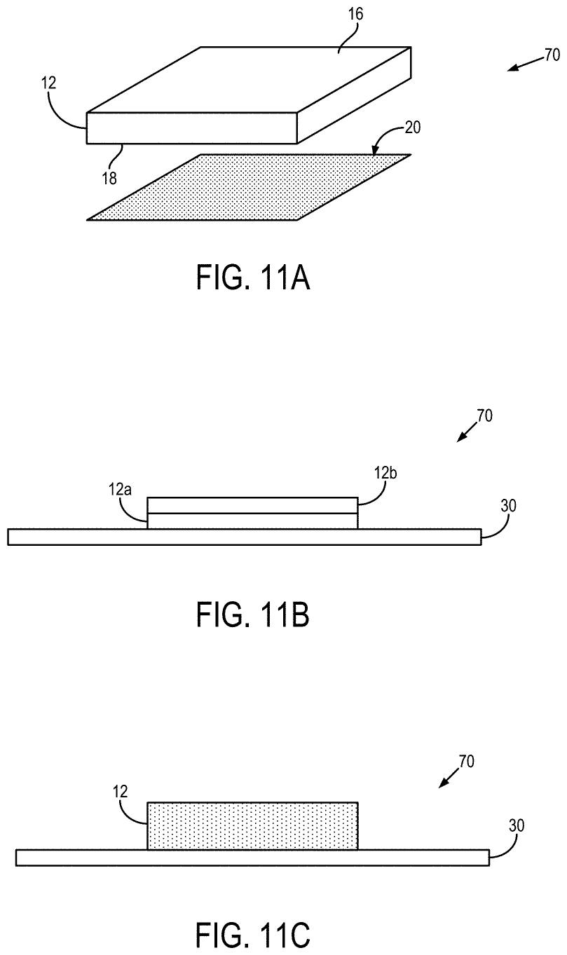

In some embodiments, the nanoparticle substrates described in the present disclosure can be configured for uses other than as an optical calibration phantom. For example, a nanoparticle substrate assembly 70 can be composed of a contrast layer 12 constructed as described above, but without a localizing grid layer, as shown in FIG. 11A. The contrast layer 12 may be arranged on or otherwise coupled to a base layer 30 as described above. In some alternative configurations, the contrast layer 12 may not be coupled to a base layer 30. As shown in FIG. 11B, in some configurations the nanoparticle substrate assembly 70 can be composed of multiple different contrast layers 12 (e.g., contrast layers 12a, 12b), which may be stacked, arrayed, or otherwise arranged as described above. As shown in FIG. 11C, in still other configurations, the nanoparticle substrate assembly 70 can include a three-dimensional contrast layer block 12 within which nanoparticles are embedded, similar to the calibration phantom described above with respect to FIG. 5. These nanoparticle substrate assemblies 70 can be used for applications other than optical calibration, such as quantum computing and/or in quantum mechanical studies.

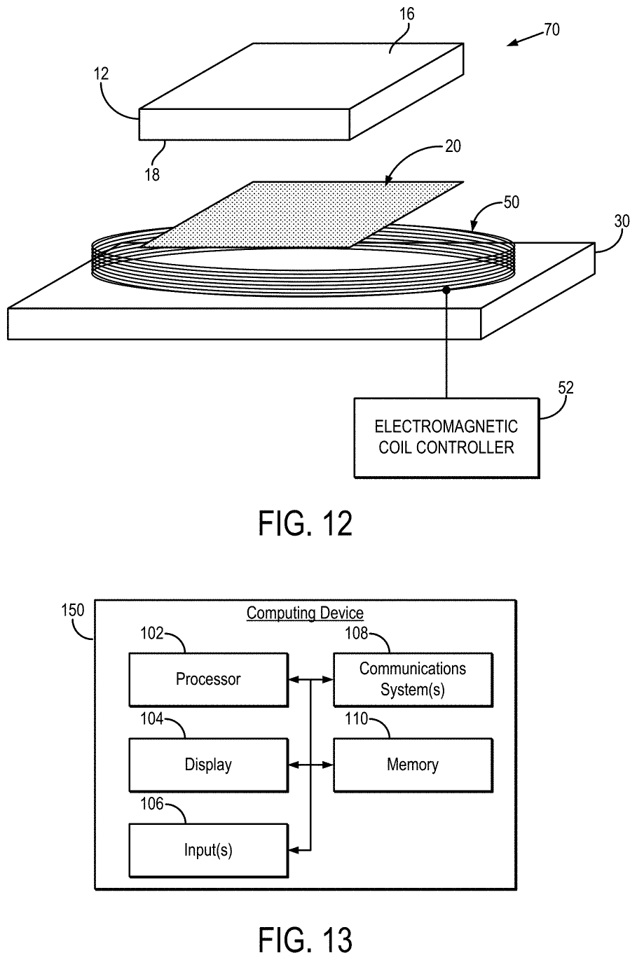

In some instances, the nanoparticle substrate assembly 70 can be used in conjunction with an electromagnetic coil 50 that is operable to generate a magnetic field that can modulate the properties of the nanoparticles 20 in the nanoparticle substrate assembly 70. For example, as described above, the magnetic field can be used to modulate the optical signature or state of the nanoparticles 20 in the nanoparticle substrate assembly 70. This control over the optical signatures and/or states of the nanoparticles 20 can be useful for applications in quantum computing, and the like. An example configuration of a nanoparticle substrate assembly 70 and electromagnetic coil 50 is shown in FIG. 12.

As shown in FIG. 13, in some embodiments, an example computing device 150 can include a processor 102, a display 104, one or more inputs 106, one or more communication systems 108, and/or memory 110. In some embodiments, processor 102 can be any suitable hardware processor or combination of processors, such as a central processing unit (“CPU”), a graphics processing unit (“GPU”), and so on. In some embodiments, display 104 can include any suitable display devices, such as a computer monitor, a touchscreen, a television, and so on. In some embodiments, inputs 106 can include any suitable input devices and/or sensors that can be used to receive user input, such as a keyboard, a mouse, a touchscreen, a microphone, and so on.

In some embodiments, communications systems 108 can include any suitable hardware, firmware, and/or software for communicating information over a communication network and/or any other suitable communication networks. For example, communications systems 108 can include one or more transceivers, one or more communication chips and/or chip sets, and so on. In a more particular example, communications systems 108 can include hardware, firmware and/or software that can be used to establish a Wi-Fi connection, a Bluetooth connection, a cellular connection, an Ethernet connection, and so on.

In some embodiments, memory 110 can include any suitable storage device or devices that can be used to store instructions, values, data, or the like, that can be used, for example, by processor 102 to present content using display 104, to communicate with a server via communications system(s) 108, and so on. Memory 110 can include any suitable volatile memory, non-volatile memory, storage, or any suitable combination thereof. For example, memory 110 can include RAM, ROM, EEPROM, one or more flash drives, one or more hard disks, one or more solid state drives, one or more optical drives, and so on. In some embodiments, memory 110 can have encoded thereon, or otherwise stored therein, a computer program for controlling operation of computing device 150. In such embodiments, processor 102 can execute at least a portion of a computer program to control the operation of the electromagnetic coil 50.

The present disclosure has described one or more preferred embodiments, and it should be appreciated that many equivalents, alternatives, variations, and modifications, aside from those expressly stated, are possible and within the scope of the invention.

1. A calibration phantom, comprising:
a contrast layer composed of an optically transparent material and having nanoparticles arranged on a surface thereof;
a localizing grid layer composed of an optically transparent material and having marked thereon a grid;
wherein the contrast layer is coupled to the localizing grid layer such that a position of each nanoparticle is fixed relative to the grid marked on the localizing grid layer.

2. The calibration phantom of claim 1, wherein the nanoparticles comprise nanocrystals.

3. The calibration phantom of claim 2, wherein the nanocrystals comprise nanodiamonds.

4. The calibration phantom of claim 2, wherein the nanocrystals comprise silicon carbide nanocrystals.

5. The calibration phantom of claim 2, wherein the nanocrystals include at least one vacancy center.

6. The calibration phantom of claim 5, wherein the nanocrystals include at least two different types of vacancy centers.

7. The calibration phantom of claim 1, wherein the contrast layer is composed of glass.

8. The calibration phantom of claim 1, wherein the nanoparticles are arranged on a lower surface of the contrast layer and the lower surface of the contrast layer is coupled to an upper surface of the localizing grid layer.

9. The calibration phantom of claim 8, wherein a lower surface of the localizing grid layer is coupled to a base layer, such that the contrast layer and the localizing grid layer are mutually coupled to the base layer.

10. The calibration phantom of claim 9, wherein the base layer is composed of at least one of glass or a polymer.

11. The calibration phantom of claim 1, wherein the localizing grid layer is composed of glass and the grid is marked on the localizing grid layer by etching the grid in the glass.

12. The calibration phantom of claim 11, wherein the grid is laser etched in the glass.

13. The calibration phantom of claim 11, wherein the grid is doped with a fluorescent media such that the grid can be visualized using a fluorescent imaging modality.

14. The calibration phantom of claim 1, further comprising at least one additional contrast layer composed of an optically transparent material and having nanoparticles arranged on a surface thereof

15. The calibration phantom of claim 14, wherein the nanoparticles are arranged on the surface of the contrast layer at a first density and the nanoparticles are arranged on the surface of the at least one additional contrast layer at a second density that is different from the first density.

16. The calibration phantom of claim 14, wherein the nanoparticles arranged on the surface of the contrast layer include a first type of vacancy center and the nanoparticles arranged on the surface of the at least one additional contrast layer include a second type of vacancy center that is different from the first type of vacancy center.

17. The calibration phantom of claim 14, wherein the nanoparticles arranged on the surface of the contrast layer comprise a first type of nanoparticle and the nanoparticles arranged on the surface of the at least one additional contrast layer comprise a second type of nanoparticle.

18. The calibration phantom of claim 1, further comprising a tissue-simulating layer coupled to the contrast layer and composed of an optically transparent material, wherein the tissue-simulating layer has an optical property that simulates an optical property of a tissue.

19. The calibration phantom of claim 18, wherein the tissue-simulating layer has a scattering agent arranged on a surface thereof, wherein the optical property of the tissue-simulating layer that simulates the optical property of the tissue is a scattering property.

20. The calibration phantom of claim 19, wherein the scattering agent is titanium dioxide.

21. The calibration phantom of claim 18, wherein the optical property of the tissue-simulating layer that simulates the optical property of the tissue is a refractive index of the tissue-simulating layer.

22. The calibration phantom of claim 18, wherein the tissue-simulating layer has an absorbing agent arranged on a surface thereof, wherein the optical property of the tissue-simulating layer that simulates the optical property of the tissue is an absorbing property.

23. The calibration phantom of claim 1, further comprising an electromagnetic coil operable to generate a magnetic field and arranged relative to the contrast layer such that when the electromagnetic coil is operated to generate the magnetic field, the magnetic field modulates at least one optical property of the nanoparticles in the contrast layer.

24. A calibration phantom, comprising:
a contrast layer block composed of an optically transparent material and having nanoparticles embedded therein;
a localizing grid layer composed of an optically transparent material and having a grid marked on a surface thereof;
wherein the contrast layer block is coupled to the localizing grid layer such that a position of each nanoparticle is fixed relative to the grid marked on the localizing grid layer.

25. The calibration phantom of claim 24, wherein the nanoparticles comprise nanocrystals.

26. The calibration phantom of claim 25, wherein the nanocrystals comprise at least one of nanodiamonds or silicon carbide nanocrystals.

27. The calibration phantom of claim 24, wherein the contrast layer block is composed of a polymer.

28. The calibration phantom of claim 24, wherein the contrast block also has a scattering agent embedded therein such that the contrast block has optical scattering properties that simulate a tissue.

29. The calibration phantom of claim 24, wherein the contrast block also has an absorbing agent embedded therein such that the contrast block has optical absorbing properties that simulate a tissue.
